(19) United States
(12) Patent Application Publication
(10) Pub. No.: US 2025/0053142 A1
(43) Pub. Date: Feb. 13, 2025

(54) COMPUTING SYSTEM

(71) Applicant: Xephor Solutions GmbH, Purkersdorf (AT)

(72) Inventor: Konstantin Oppl, Purkersdorf (AT)

(21) Appl. No.: 18/720,124

(22) PCT Filed: Nov. 14, 2022
(86) PCT No.: PCT/AT2022/060396

§ 371 Date: Jun. 14, 2024

(51) Int. Cl. G05B 13/02; H04L 67/025

(52) U.S. Cl. CPC G05B 13/0265; H04L 67/025

(57) ABSTRACT

A computing system. a method for operating a computer system, a computer program, a computer-readable medium and a data carrier signal with improved communication between remote user devices (RU) and an artificial intelligence (AGI) by way of different virtual users (AVU).

The present invention relates to the field of a computing system, a method for operating a computer system, a computer program, a computer-readable medium and a data carrier signal with improved communication between users and an artificial intelligence by way of different virtual users.

### BACKGROUND

Often, for a human user of a computing system, there are long waiting times for complex data manipulations to be completed by the computing system which might be interrupted by the computing system querying the user for additional information. The user has to check in repeatedly to make sure that the data manipulations proceed as planned. It would be advantageous, if the user were able to delegate these tasks.

In other situations, a human user might be replaceable by a robot or an autonomous device such as an autonomous vehicle. However, in order for a robot or an autonomous vehicle to function properly their surroundings have to be monitored continuously, e. g., by capturing a video stream or a plurality of photos, such that the position and velocity of the robot or vehicle and the presence of obstacles can be discovered in time. Such monitoring produces a large amount of data. Conventionally, the robot or autonomous vehicle has to be equipped with enough electronic memory to be able to store the data.

EP 1 977 347 B1 describes an attempt for seamless integration of multiple computing environments.

EP 2 106 669 B1 describes a proxy system for managing mobile devices.

EP 2 863 340 B1 describes intelligent agents which are able to share their memories and incorporate knowledge from other intelligent agents.

U.S. Pat. No. 7,861,252 B2 relates to an architecture for an intelligent software agent system.

U.S. Pat. No. 8,407,263 B2 relates to a collaboration portal for providing computer-accessible benefits for communities of users.

U.S. Pat. No. 9,384,043 B2 relates to a computing system that uses task execution and delegation of autonomous mobile agents based on an intent knowledge base.

U.S. Pat. No. 10,452,674 B2 relates to an artificial intelligence and robotic process automation for automated data management.

U.S. Pat. No. 10,983,843 B2 relates to an event-driven programming model based on asynchronous, massively parallel dataflow processes for highly-scalable distributed applications.

US 2017/0293845 A1 relates to a computing system for content recommendation and provisioning based on artificial intelligence.

US 2019/0273662 A1 relates to a method for providing cognitive functions and for facilitating management in cognitive network management systems.

WO 2017/132590 A1 discloses trained artificial intelligence objects that can be reused, reconfigured and recomposed into artificial intelligence models.

There is a need for a computing system, a method and a computer program which addresses the above-mentioned drawbacks.

### SUMMARY OF INVENTION

### Terminology

The term “data manipulation” is understood to encompass inspecting, transforming, modeling, interpreting, classifying, visualizing data for any kind of purpose.

The term “computing device” encompasses any processor which performs operations on data such as a central processing unit of a system, a co-processor, a Graphics Processing Unit, a Vision Processing Unit, a Tensor Processing Unit, an FPGA, an ASIC, a Neural Processing Unit, . . . .

The term “thread of execution” (sometimes simply referred to as “thread”) is defined as the smallest sequence of programmed instructions that can be managed by a scheduler of an operating system. Another term for “thread” is “sub-process”. By way of example, each thread of execution can be executed by one processing entity of a computing device. A computing device can provide a number of processing entities to the operating system of the system.

The term “machine learning method” is meant to signify the ability of a system to achieve a desired performance, at least partially by exposure to data without the need to follow explicitly programmed instructions, e. g., relying on patterns and/or inference instead. Machine learning methods include the use of artificial neuronal networks (in short “ANNs”, also called neuronal networks in this disclosure).

It is to be understood that in the context of this disclosure “different” ANNs can mean networks which differ in type (e. g., classical or Quantum CNNs, RNNs such as LSTMs, ARTS, . . . ) and/or in the specific setup of the network (e. g., number of layers, types of layers, number of neurons per layer, connections between neurons, number of synaptic weights other parameters of the network, . . . .

A suitable artificial intelligence is described, e. g., in WO 2022/043086 A1, the contents of which is hereby incorporated by reference.

A suitable hardware for running the computing environment is described, e. g., in U.S. Pat. No. 10,838,903 B2, the contents of which is hereby incorporated by reference.

It is an object of this invention to provide a computing system, a method for operating a computer system and a computer program which allow a user (human user, autonomous device, software program, . . . ) to manage complex data manipulations in an efficient way.

It is another object of this invention to provide a, preferably non-transient, computer-readable medium comprising such a computer program.

It is yet another object of this invention to provide a data carrier signal carrying such a computer program.

In one aspect of the invention there is provided a computing system, comprising:
a computing environment having at least one computing device configured to communicate
   via a communication network with a plurality of remote user computing devices each of which is configured to run a user identification process
   via a communication network with at least one remote computing device which is preferably configured to run an artificial intelligence
a plurality of remote user computing devices each of which is configured to run a user identification process and to log on to the computing environment via a data exchange interface for exchanging information when being operatively connected to the computing environment via a communication network
at least one remote computing device which is configured to run an artificial intelligence and a data exchange interface for exchanging information with the computing environment when being operatively connected to the computing environment via a communication network
   said at least one computing device of the computing environment being configured to execute in parallel a plurality of processes, said plurality of processes comprising at least:
at least one shared memory process
a plurality of agents in the form of avatar virtual users wherein each avatar virtual user is configured to exchange information with a specific remote user computing device which has a specific user identification process, in case the remote user computing device is logged on to the computing environment, and to obtain information from and to make available information to the at least one shared memory process
a plurality of agents in the form of robotic virtual users wherein each robotic virtual user is configured to run a robotic process automation and is configured to obtain information from and to make available information to the at least one shared memory process
at least one agent in the form of a system virtual user being configured to exchange information with the data exchange interface of the at least one remote computing device that is preferably configured to run an artificial intelligence and to obtain information from and to make available information to the at least one shared memory process
   wherein, in case one of the plurality of remote user computing devices logs on to the computing environment, the at least one computing device of the computing environment is configured to check whether there exists an avatar virtual user which is configured to exchange information with the remote computing device that is logging on and, in case such an avatar virtual user exists, synchronize information between the remote user computing device and the avatar virtual user, said synchronized information comprising
information which is at least in part to be operated on by the remote computing system, preferably by the artificial intelligence, and/or
information which is at least in part a result of an operation by the remote computing system, preferably by the artificial intelligence

In another aspect of the invention there is provided a method for operating a computing system, comprising:
providing a computing environment having at least one computing device configured to communicate
   via a communication network with a plurality of remote user computing devices each of which is configured to run a user identification process
   via a communication network with at least one remote computing device which is preferably configured to run an artificial intelligence
a plurality of remote user computing devices each of which is configured to run a user identification process and to log on to the computing environment via a data exchange interface for exchanging information when being operatively connected to the computing environment via a communication network
at least one remote computing device which is configured to run an artificial intelligence and a data exchange interface for exchanging information with the computing environment when being operatively connected to the computing environment via a communication network
   said at least one computing device of the computing environment executing in parallel a plurality of processes, said plurality of processes comprising at least:
at least one shared memory process
a plurality of agents in the form of avatar virtual users wherein each avatar virtual user is configured to exchange information with a remote user computing device having a specific user identification process, in case the remote user computing device is logged on to the computing environment, and to obtain information from and to make available information to the at least one shared memory process
a plurality of agents in the form of robotic virtual users each of which running a robotic process automation and being configured to obtain information from and to make available information to the at least one shared memory process
at least one agent in the form of system virtual user being configured to exchange information with the data exchange interface of the at least one remote computing device that is preferably configured to run an artificial intelligence and to obtain information from and to make available information to the at least one shared memory process
   wherein, in case one of the plurality of remote user computing devices logs on to the computing environment, the at least one computing device of the computing environment checks whether there exists an avatar virtual user which is configured to exchange information with the remote computing device that is logging on and, in case such an avatar virtual user exists, synchronizes information between the remote user computing device and the avatar virtual user, said synchronized information comprising
information which is at least in part to be operated on by remote computing system, preferably by the artificial intelligence, and/or
information which is at least in part a result of an operation by the remote computing system, preferably by the artificial intelligence

In yet another aspect of the invention there is provided a computer program which when the program is executed by a computing device, causes the computing device to be configured to communicate
via a communication network with a plurality of remote user computing devices each of which is configured to run a user identification process
via a communication network with at least one remote computing device which is preferably configured to run an artificial intelligence
   and to execute in parallel a plurality of processes, said plurality of processes comprising at least:
at least one shared memory process
a plurality of agents in the form of avatar virtual users wherein each avatar virtual user is configured to exchange information with a remote user computing device having a specific user identification process, in case the remote user computing device is logged on to the computing environment, and to obtain information from and to make available information to the at least one shared memory process
a plurality of agents in the form of robotic virtual users each of which running a robotic process automation and being configured to obtain information from and to make available information to the at least one shared memory process
at least one agent in the form of system virtual user being configured to exchange information with the data exchange interface of the at least one remote computing device that is preferably configured to run an artificial intelligence and to obtain information from and to make available information to the at least one shared memory process
   wherein, in case one of the plurality of remote user computing devices logs on to the computing environment, the at least one computing device of the computing environment is configured to check whether there exists an avatar virtual user which is configured to exchange information with the remote computing device that is logging on and, in case such an avatar virtual user exists, synchronize information between the remote user computing device and the avatar virtual user, said synchronized information comprising
information which is at least in part to be operated on by the remote computing system, preferably by the artificial intelligence, and/or
information which is at least in part a result of an operation by the remote computing system, preferably by the artificial intelligence

In yet another aspect of the invention there is provided a, preferably non-transient, computer-readable medium comprising a computer program as described above.

In yet another aspect of the invention there is provided a data carrier signal comprising a computer program as described above.

Preferred embodiments of the invention are defined in dependent claims.

The role of an avatar virtual user is to act as a representative of a user in the real world. For this reason, each avatar virtual user is configured to exchange information with a specific remote user computing device which is used by a specific user to log on to the computing environment. Identification of the user is done by a user identification process (which can encompass any kind of security protocol known in the art) running on the remote user computing device. The connection between a specific remote user computing device and its avatar virtual user is done by the data exchange interface which serves as an address database. In other words, an avatar virtual user is a connection of the computing system with the real world.

The avatar virtual user represents the real user during interactions with other components of the computing environment such as the robotic virtual users (which serve to work on menial tasks such as working on fixed scripts and/or collect information from remote databases) and the system virtual user which is the connection to the remote computing system, in particular to the artificial intelligence.

Avatar virtual users can have different rights in the computing environment. For example, one or more avatar virtual users can have administrator rights within the computing environment.

An avatar virtual user can be provided with at least one interface that enables it to understand instructions which are specific to some third-party-applications. The at least one interface can be secured by a cryptographic key.

The role of a robotic virtual user is to deal with tasks which do not need a lot of flexibility such as running a script. A robotic virtual user can receive tasks (even whole scripts) from and report to avatar virtual users.

The system virtual user has the task of providing the avatar virtual user with a communication means with the remote computing system, in particular the artificial intelligence, without the need for the avatar virtual user to learn the specific protocol that might be necessary to communicate with the remote computing system, in particular the artificial intelligence. Such protocols are known to the system virtual user.

Preferably the system virtual user is provided with at least one artificial neuronal network for data processing.

It can be provided that the system virtual user keeps track of which avatar virtual users communicated with the system virtual user such that it can correctly send data to an avatar virtual user.

Whenever a remote user computing devices logs on to the computing environment via the data exchange interface the avatar virtual user synchronizes information with its remote user computing device. The avatar virtual user receives information which is at least in part to be operated on by the remote computing system, in particular the artificial intelligence and provides the remote user computing device with information which is at least in part a result of an operation by the remote computing system, in particular by the artificial intelligence, and—as the case might be—also includes information which is based on the operation of one or more robotic virtual user.

In order to allow for secure communication, the data exchange interface can comprise any type of security protocol known in the art, e. g., biometric verification of a real user, and so on. In order to be able to run more complex security protocols it can be provided that the data exchange interface can be provided with an artificial intelligence comprising artificial neuronal networks.

All of the different types of users within the computing environment can be seen as threads from the standpoint of a programmer.

The computing system can be distributed on different servers.

Alternatively to running an artificial intelligence, or in addition to, the remote computing system can run a database or a third-party-application.

### DESCRIPTION OF EMBODIMENTS

In some embodiments of the computer system and method at least one of the plurality of robotic virtual users is configured to access a remote source information via a communication network.

In some embodiments of the computer system and method at least one of the plurality of robotic virtual users is configured to receive or obtain information from the at least one system virtual user and to perform an operation on said received information such that the synchronized information comprising at least in part a result of an operation by the remote computing system, in particular the artificial intelligence, contains or consists of a result of an operation of the at least one robotic virtual user.

In some embodiments of the computer system and method at least one of the plurality of remote user computing devices is one of the following:
a computing device running a human-machine-interface
a sensor
an actor
an interface of a computer program

In some embodiments of the computer system and method the at least one computing device of the computing environment is configured to send a sleep and/or a wake command to an avatar virtual user.

In some embodiments of the computer system and method at least one of the avatar virtual users, preferably a plurality or all of the avatar virtual users, comprises at least one artificial neuronal network for data processing.

In some embodiments of the computer system and method at least some of the plurality of avatar virtual users comprise at least one genetic algorithm and the at least one computing device of the computing environment is configured to perform crossover operations on the genetic algorithms of different avatar virtual users.

In some embodiments of the computer system and method the artificial intelligence run by the remote computing system comprises a general artificial intelligence, i. e., a plurality of different artificial neuronal networks for employing machine learning methods as described in WO 2022/043086 A1 which is incorporated herein by reference.

As a non-limiting example, the operation of a robot or an autonomous vehicle, such as an UAV, is discussed.

In order for a robot or an autonomous device such as a vehicle to function properly their surroundings have to be monitored continuously, e. g., by capturing a video stream or a plurality of photos, such that the position and velocity of the robot or vehicle and the presence of obstacles can be discovered in time. Such monitoring produces a large amount of data. Conventionally, the robot or vehicle has to be equipped with enough electronic memory to be able to store the data.

The robot or autonomous device runs a software which configures the robot or device to function as a remote user computing device. Data manipulation necessary to analyze the photos or video stream captured by the robot or device is done, at least in part, by the artificial intelligence. Motion commands are sent back to the robot or autonomous device.

As another non-limiting example, the operation of a method for condition monitoring of an industrial facility is discussed.

Different monitoring systems of the industrial facility run a software which configures them to function as remote user computing devices. Data manipulation necessary to analyze the data provided by sensors of the monitoring system is done, at least in part, by the artificial intelligence. Information about the condition of the monitored system is sent back to the monitoring systems which-if necessary-can put out an alert.

It is possible to have more than one of the above-described computing systems which can communicate which each other by using communication networks via network connections.

### BRIEF DESCRIPTION OF DRAWINGS

FIG. 1 shows a computing system according to an embodiment of the invention.

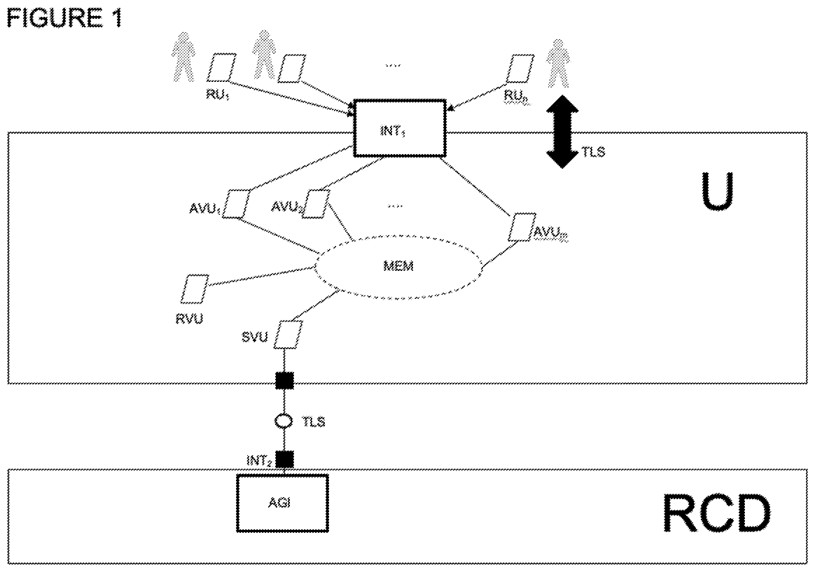

In FIG. 1 a computing system is shown, comprising:
a computing environment U having at least one computing device
a plurality of remote user computing devices RU₁, . . . RUₙ
a remote computing device configured to run an artificial intelligence AGI
   These components of the computing system form a distributed system and communicate with each other via communication networks such as the internet. A data exchange interface INTI is configured to provide a log-in-service to the remote user computing devices RU₁, . . . RUₙ and to handle the exchange of information between remote user computing devices RU₁, . . . RUₙ and the computer environment U.

The at least one computing device of the computing environment U is configured to execute in parallel a plurality of processes, comprising:
a shared memory process MEM
a plurality of avatar virtual users AVU₁, . . . , AVUₘ which are autonomous processes containing information from real users which was input via remote user computing devices RU₁, . . . , RUₙ; each avatar virtual user AVU forms a thread
a plurality of robotic virtual users RVU₁, . . . , RVU₁ executing scripts or programs
a system virtual user SVU (there can be several system virtual users each communicating with its own artificial intelligence AGI)
   Communication between these processes happens within the computing environment U only (preferably only via the shared memory process MEM), such that the computing environment U forms a closed environment. Communication with the outside, i. e., the plurality of remote user computing devices RU₁, . . . , RUₙ and the remote computing device configured to run an artificial intelligence AGI is managed via separate data exchange interfaces INT₁, INT₂ which are configured for secure communication. There can also be provided a data exchange interface (not shown) for the plurality of robotic virtual users RVU₁, . . . , RVU₁ enabling them to access a remote source information via a communication network.

Each of the plurality of remote user computing devices RU₁, . . . , RUₙ is configured to run a user identification process and to log on to the computing environment U for exchanging information when being operatively connected to the computing environment U via a communication network, e. g., the internet.

Each of the plurality of agents in the form of avatar virtual users AVU₁, . . . , AVUₘ is configured to exchange information with a specific remote user computing device RU₁, . . . , RUₙ which has a specific user identification process, in case the remote user computing device RU₁, . . . , RUₙ is logged on to the computing environment U, and is configured to obtain information from and to make available information to the at least one shared memory process MEM.

Each of the plurality of agents in the form of robotic virtual users RVU₁, . . . , RVU₁ is configured to run a robotic process automation in the form of fixed scripts and is configured to obtain information from and to make available information to the at least one shared memory process MEM. At least some of the robotic virtual users RVU₁, . . . , RVU₁ can be configured to

The system virtual user SVU servers to organize the communication with the artificial intelligence AGI.

In case one of the plurality of remote user computing devices RU₁, . . . , RUₙ logs on to the computing environment U, the at least one computing device of the computing environment U is configured to check whether there exists an avatar virtual user AVU₁, . . . , AVUₘ which is configured to exchange information with the remote user computing device RU₁, . . . , RUₙ that is logging on and, in case such an avatar virtual user AVU₁, . . . , AVUₘ exists, is configured to synchronize information between the remote user computing device RU₁, . . . , RUₙ and the avatar virtual user AVU₁, . . . , AVUₘ, said synchronized information comprising
information which is at least in part to be operated on by the artificial intelligence AGI and/or
information which is at least in part a result of an operation by the artificial intelligence AGI

### REFERENCE SIGNS LIST

U computing environment
RU remote user device
INT data exchange interface
AGI artificial intelligence
MEM shared memory process
AVU avatar virtual user
RVU robotic virtual user
SVU system virtual user

1. A computing system, comprising:
a computing environment having at least one computing device configured to communicate
via a communication network with a plurality of remote user computing devices each of which is configured to run a user identification process
via a communication network with at least one remote computing device which is configured to run an artificial intelligence
a plurality of remote user computing devices each of which is configured to run a user identification process and to log on to the computing environment via a data exchange interface for exchanging information when being operatively connected to the computing environment via a communication network
at least one remote computing device which is configured to run a data exchange interface for exchanging information with the computing environment when being operatively connected to the computing environment via a communication network
said at least one computing device of the computing environment being configured to execute in parallel a plurality of processes, said plurality of processes comprising at least:
at least one shared memory process
a plurality of agents in the form of avatar virtual users wherein each avatar virtual user is configured to exchange information with a specific remote user computing device which has a specific user identification process, in case the remote user computing device is logged on to the computing environment, and is configured to obtain information from and to make available information to the at least one shared memory process
a plurality of agents in the form of robotic virtual users wherein each robotic virtual user is configured to run a robotic process automation and is configured to obtain information from and to make available information to the at least one shared memory process
at least one agent in the form of a system virtual user being configured to exchange information with the data exchange interface of the at least one remote computing device and to obtain information from and to make available information to the at least one shared memory process
wherein, in case one of the plurality of remote user computing devices logs on to the computing environment, the at least one computing device of the computing environment is configured to check whether there exists an avatar virtual user which is configured to exchange information with the remote user computing device that is logging on and, in case such an avatar virtual user exists, is configured to synchronize information between the remote user computing device and the avatar virtual user, said synchronized information comprising at least one of
information which is at least in part to be operated on by the remote computing device, and
information which is at least in part a result of an operation by the remote computing device.

2. The computing system according to claim 1, wherein at least one of the plurality of robotic virtual users is configured to access a remote source information via a communication network.

3. The computing system according to claim 1, wherein at least one of the plurality of robotic virtual users is configured to receive or obtain information from the at least one system virtual user and to perform an operation on said received information such that the synchronized information comprising at least in part a result of an operation by the remote computing device contains or consists of a result of an operation of the at least one robotic virtual user.

4. The computing system according to claim 1, wherein at least one of the plurality of remote user computing devices is one of the following:
a computing device running a human-machine-interface
a sensor
an actor
an interface of a computer program

5. The computing system according to claim 1, wherein the at least one computing device of the computing environment is configured to send a sleep and/or a wake command to an avatar virtual user.

6. The computing system according to claim 1, wherein at least one of the avatar virtual users, preferably a plurality or all of the avatar virtual users, comprises at least one artificial neuronal network for data manipulation.

7. The computing system according to claim 1, wherein at least some of the plurality of avatar virtual users comprise at least one genetic algorithm and the at least one computing device of the computing environment is configured to perform crossover operations on the genetic algorithms of different avatar virtual users.

8. The computing system according to claim 1, wherein the artificial intelligence comprises a plurality of different artificial neuronal networks for employing machine learning methods.

9. The computing system according to claim 1, wherein at least one of the plurality of robotic virtual users is configured to access a remote source information via a communication network.

10. The computing system according to claim 1, wherein the remote computing system is configured to run an artificial intelligence (AGI) and said synchronized information comprises at least one of
information which is at least in part to be operated on by artificial intelligence (AGI), and
information which is at least in part a result of an operation by the artificial intelligence (AGI)

11. A method for operating a computing system, comprising:
providing a computing environment having at least one computing device configured to communicate
via a communication network with a plurality of remote user computing devices each of which is configured to run a user identification process
via a communication network with at least one remote computing device
a plurality of remote user computing devices each of which is configured to run a user identification process and to log on to the computing environment via a data exchange interface for exchanging information when being operatively connected to the computing environment via a communication network
at least one remote computing device which is configured to run a data exchange interface for exchanging information with the computing environment when being operatively connected to the computing environment via a communication network and which is preferably configured to run an artificial intelligence
said at least one computing device of the computing environment executing in parallel a plurality of processes, said plurality of processes comprising at least:
at least one shared memory process
a plurality of agents in the form of avatar virtual users wherein each avatar virtual user is configured to exchange information with a remote user computing device having a specific user identification process, in case the remote user computing device is logged on to the computing environment, and to obtain information from and to make available information to the at least one shared memory process
a plurality of agents in the form of robotic virtual users each of which running a robotic process automation and being configured to obtain information from and to make available information to the at least one shared memory process
at least one agent in the form of system virtual user being configured to exchange information with the data exchange interface of the at least one remote computing device and to obtain information from and to make available information to the at least one shared memory process
wherein, in case one of the plurality of remote user computing devices logs on to the computing environment, the at least one computing device of the computing environment checks whether there exists an avatar virtual user which is configured to exchange information with the remote computing device that is logging on and, in case such an avatar virtual user exists, synchronizes information between the remote user computing device and the avatar virtual user, said synchronized information comprising at least one of
information which is at least in part to be operated on by the remote computing device, preferably by the artificial intelligence, and
information which is at least in part a result of an operation by the remote computing device, preferably by the artificial intelligence.

12. A computer program which when the program is executed by a computing device, causes the computing device to be configured to communicate
via a communication network with a plurality of remote user computing devices each of which is configured to run a user identification process
via a communication network with at least one remote computing device which is preferably configured to run an artificial intelligence
and to execute in parallel a plurality of processes, said plurality of processes comprising at least:
at least one shared memory process
a plurality of agents in the form of avatar virtual users wherein each avatar virtual user is configured to exchange information with a remote user computing device having a specific user identification process, in case the remote user computing device is logged on to the computing environment via a data exchange interface, and to obtain information from and to make available information to the at least one shared memory process
a plurality of agents in the form of robotic virtual users each of which running a robotic process automation and being configured to obtain information from and to make available information to the at least one shared memory process
at least one agent in the form of system virtual user being configured to exchange information with the data exchange interface of the at least one remote computing device that is configured to run an artificial intelligence and to obtain information from and to make available information to the at least one shared memory process
wherein, in case one of the plurality of remote user computing devices logs on to the computing environment, the at least one computing device of the computing environment is configured to check whether there exists an avatar virtual user which is configured to exchange information with the remote user computing device that is logging on and, in case such an avatar virtual user exists, synchronize information between the remote user computing device and the avatar virtual user, said synchronized information comprising at least one of
information which is at least in part to be operated on by the remote computing device, preferably by the artificial intelligence,
information which is at least in part a result of an operation by the remote computing device, preferably by the artificial intelligence.

13. A computer-readable medium comprising the computer program according to claim 12.

14. A data carrier signal carrying the computer program according to claim 12.
